(19) United States
(12) Patent Application Publication
(10) Pub. No.: US 2007/0154864 A1
(43) Pub. Date: Jul. 5, 2007

(54) Method of manufacturing a dental part

(75) Inventors: Daniel John Deer, Chepstow (GB); Geoffrey McFarland, Dursley (GB)

Correspondence Address: OLIFF & BERRIDGE, PLC, P.O. BOX 19928, ALEXANDRIA, VA, 22320, US

(73) Assignee: RENISHAW PLC

(21) Appl. No.: 10/588,162

(22) PCT Filed: Feb. 7, 2005
(86) PCT No.: PCT/GB05/00418

§ 371 Date: Aug. 1, 2006

(30) Foreign Application Priority Data
Feb. 7, 2004 (GB) 0402743.9

(51) Int. Cl. A61C 11/00

(52) U.S. Cl. 433/213

(57) ABSTRACT

A method of manufacturing a fixed denture (18,58) is disclosed comprising, identifying the surface of a tooth preparation (110), relating the identified surface to a near net shape version of the denture (120), and altering the near net shape version (130) to produce a denture having an inner profile which substantially replicates the surface of the tooth preparation (140). The inner profile may include an offset (36). The surface of the tooth may be identified by digitising the surface. The near net shape can be altered by machining. The near net shape version may be a pre-formed sintered ceramic shell (20) which may comprise one of a plurality of standard tooth shapes (40) from which the most appropriate shape is chosen or an individually produced tooth shape (42). The fixed denture may be for example a coping (18), bridge (58), implant support abutment.

This invention relates to a method of manufacturing a fixed denture and in particular replacement teeth and bridges.

It is known to produce a coping (replacement shell) for a damaged tooth by taking an impression of a jaw and from this, making a positive cast of the tooth. This can be digitised, and a coping machined to size and shape from a block of ceramic however, such ceramic blocks are difficult to machine so, usually a shell is formed (by a pressing or moulding or casting technique) over the cast in a green state and sintered. Finally an enamel coating is added to produce the crown. When the ceramic shell is sintered, it shrinks and this can lead to a mis-match between the tooth preparation and shell.

It is known to make a bridge or a coping by taking an impression of a jaw and from this producing a positive cast of the relevant part of the jaw. Next, a wax pattern is produced which, for a bridge, consists of a replacement wax replica tooth or teeth between the supporting teeth, wax copings over the supporting teeth and connecting portions of wax between the teeth. For a coping, the wax pattern consists of a wax shell for the tooth which is being repaired. The wax pattern is used as the pattern for the investment casting of a metal bridge frame or coping which is subsequently covered with enamel to produce the final bridge or coping.

According to a first aspect the invention comprises a method of manufacturing a fixed denture comprising:
identifying the surface of a tooth preparation;
relating the identified surface to a near net shape version of the denture; and
altering the near net shape version (130) to produce a denture having an inner profile which substantially replicates the surface of the tooth preparation.

A fixed denture is a denture which is, in use, secured permanently in the mouth and includes partial dentures such as crowns, bridges and implant supported abutments as well as full arch dentures.

The production of a near net shape reduces machining time and material costs. The effects of shrinkage of the part during processing is mitigated. The cycle time for the production of a denture from the initial visit to a dentist when an impression is taken to the fitting of the denture can be reduced. Additionally, due to there being minimal machining a more accurate part can be made as the influence of tool wear is minimised.

It is preferred that the surface is identified by scanning a required shape of the fixed denture to producing digitised data, for example, by scanning the relevant part of an impression or a cast stone model made from an impression of the patients' mouth. In order to produce the required shape, the digitised data may be manipulated for example, by overlaying a wax model of the denture on an impression or cast, utilising CAD/CAM or, reconstructing the data from a reference point.

The near net shape version of the denture can be produced in a number of ways including machining from a block of green state ceramic; single or double sided pressing using a mould made specifically for that denture or; single or double sided pressing using one of a plurality of stock moulds which produces a standard shapes for dentures, and choosing the most appropriate one.

The invention will now be described by example and with reference to the accompanying drawings, of which:

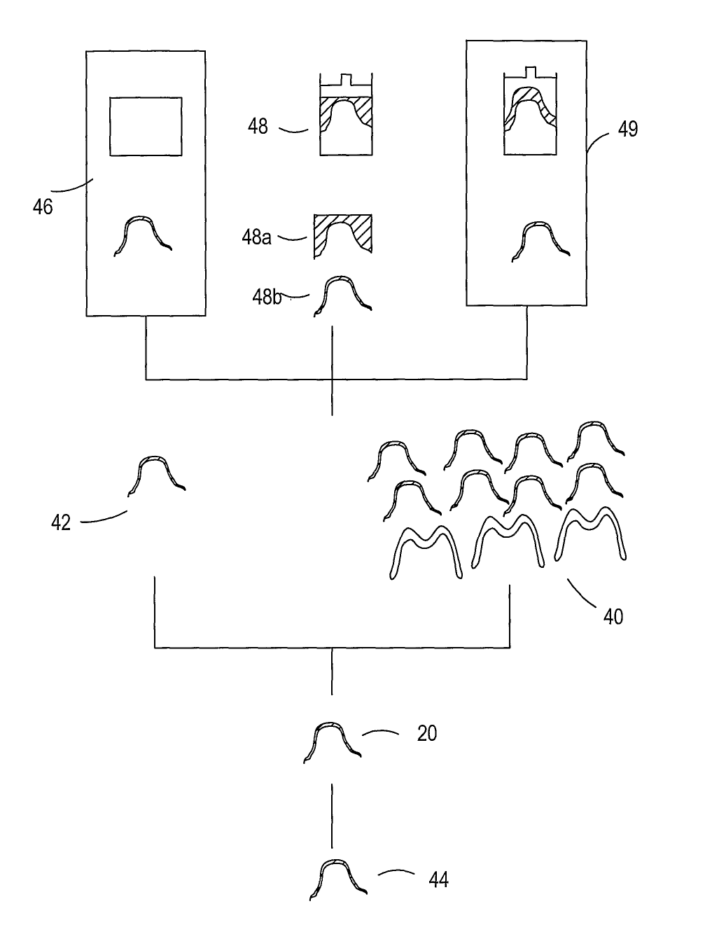

FIG. 1 shows schematically the production of a fixed denture according to the invention;

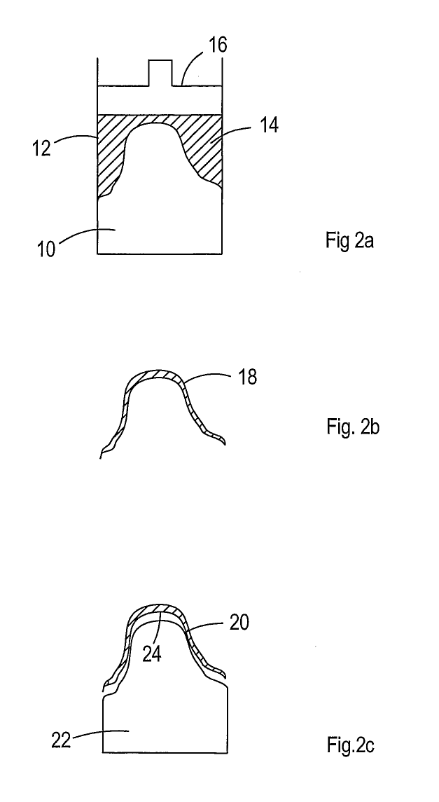

FIGS. 2a,b, c and d show schematically the production of a coping according to the invention;

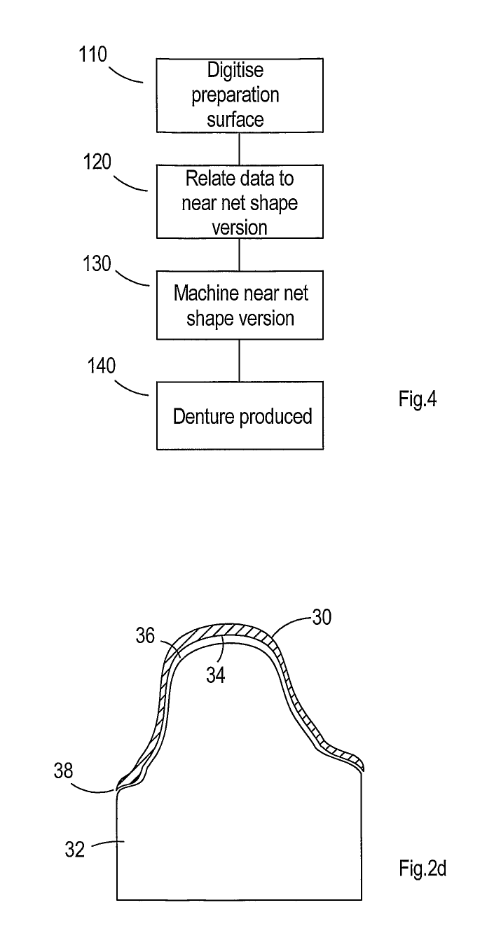

FIGS. 3a,b and c show schematically stages in the production of a bridge according to the invention; and

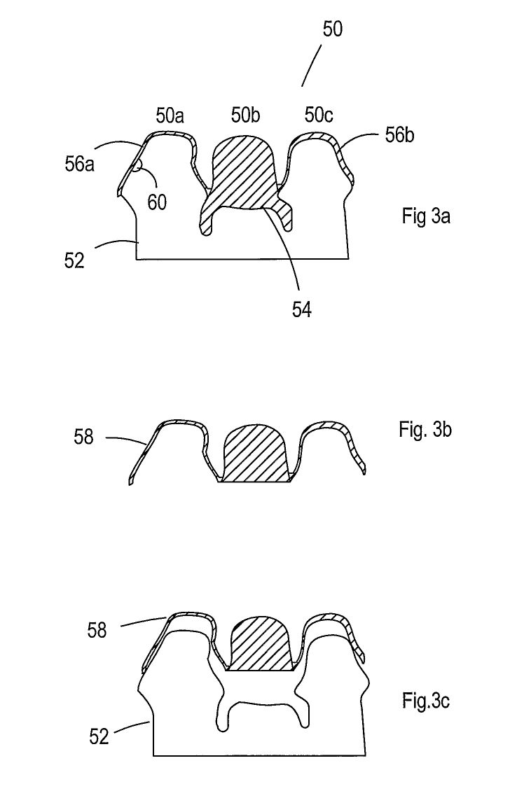

FIG. 4 is a flow diagram detailing steps of the invention.

FIG. 1 shows a pre-formed sintered ceramic shell 20 which is a near net shape version of a denture. The pre-formed sintered ceramic shell 20 may be an individually produced tooth shape 42 which has been specifically manufactured to produce a denture. Alternatively, the pre-formed sintered ceramic shell 20 may be one of a plurality of standard tooth shapes 40 which have been mass produced ready for selection or which are manufactured from one of a plurality of stock moulds on demand.

The pre-formed sintered ceramic shell 20 is produced by, machining from a block of green state ceramic material 46 or, single sided pressing of green state ceramic 48 to produce an inner profile 48a then machining the unshaped surface to produce the outer profile 48b or, double sided pressing of a green state ceramic 49 followed by sintering the green state shape. For individually produced tooth shapes 42, the shrinkage that occurs during sintering must be accounted for by making an oversized green state shape.

Alternatively, the pre-formed sintered shell can be machined from a block of sintered ceramic. This procedure can be carried out overnight or on a rough cutting machine to save on processing time.

To produce the denture 44, the pre-formed sintered ceramic shell 20 is ground so it replicates the surface profile of the tooth preparation. This replication can include an offset for example to provide a cement gap. The size of the cement gap is a function of the cement that is used. Additionally, the thickness of the ceramic shell can also be determined using an offset.

FIG. 2a shows the production of a coping using single sided moulding. Ceramic material 14 is provided between the cast of the tooth form 10 and a press 16 which bears down on the ceramic material 14 towards the cast 10.

The press 16 is used to compact ceramic material 14 against the cast of the tooth form 10 so the ceramic material 14 takes the shape of the outer surface of the cast of the tooth 10.

When a flat press is used (as shown in FIG. 2a) only the inner surface of the coping is formed as the inner surface of the coping replicates the outer surface of the cast of the tooth form 10. In this case, in order to produce an outer surface, the compressed ceramic is machined when in a green state to produce a green state coping 18 (see FIG. 2b).

Alternatively, the press may have a shaped surface for example it could be formed as one of a standard set of tooth shapes which are selected depending on which type of tooth is required, the age of the patient etc. In this case both the inner and outer surface of the coping is moulded into shape and little or no machining of the green ceramic is required to produce a green state coping 18 (see FIG. 2b). The standard set of tooth shapes can be pre-made and selected following assessment of the coping requirements.

Once the green state coping 18 has been formed it is sintered and during this process the ceramic material will shrink.

Instead of producing a green state ceramic from a standard set of press shapes, a plurality of standard tooth shapes is provided already sintered and once the cast of the tooth has been made, its shape is digitised and compared to the standard set. This comparison may be done by an operator or, software which selects the most appropriate shape from the set of standard shapes. The difference between the standard shape and the ideal or required shape is programmed into a machine tool to produce the ideal coping. Best fit techniques can be used to choose the most appropriate shape. Ideally, the standard tooth shape which is chosen will completely encase the required shape and necessitate the least amount of machining.

Alternatively, the coping is made from metal and is made using investment casting. In this case, a wax (or other suitable material) replica of a coping is made using the cast of the tooth form. The wax replica is dipped in slip to produce a ceramic mould of the coping. The wax is removed and the mould filled with molten metal which solidifies to form a metal coping. Again, the coping could be selected from a mass produced standard set and differences programmed into a machine tool. This has the advantage that the skilled manual labour which is traditionally used can be removed. As with a ceramic coping, the metal coping is subject to shrinkage as it solidifies.

A solution to the shrinkage of both ceramic and metal copings is to produce an oversized coping. However, there are problems with this, for example, the cast of the tooth must be made oversized. Also, the shrinkage of the material used needs to be consistent both within a single coping and across material batches.

If the shrinkage is not taken into account during the manufacturing process, and the resultant coping 20 is replaced over the cast of the tooth form 22, instead of fitting against the outer surface of the cast of the tooth form, the coping will be slightly undersized (FIG. 2c). In this example the effect has been exaggerated.

In order to enable more accurate positioning of the coping 20 onto the cast of the tooth form 22 and thus also the tooth on which the coping is destined to sit without having to resort to the production of oversized parts, the inner surface 24 of the coping 20 is machined until it replicates the outer surface of the cast of the tooth form 22 accurately.

FIG. 2d shows a coping 30 in use. In order to secure the coping 30 to a tooth 32, cement is used. Thus, in addition to shrinkage of the coping, to ensure accurate fitting of the coping 30, an offset 36 (the cement gap) is provided between the inner surface 34 of the coping 30 and the outer surface of the tooth 32 to accommodate the cement. Typically, the offset varies from about 50-70 microns around the margin line 38 (where the gum meets the tooth) to 150 microns at other places. The accuracy around the margin line is important as this determines the aesthetics and integrity of the final crown.

One way to establish where to machine the inner surface 24 for accurate replication is to compare the contours of the inner surface 24 with those of the cast of the tooth form 22 and machine away any discrepancies. Traditionally, the cast of the tooth form 22 is a plaster cast which has been produced using an impression of the actual tooth which is being repaired. The outer surface of the cast is digitised as is the inner surface 24 of the ceramic coating 22 and the resultant digitised forms are compared to establish where there are discrepancies between the two surfaces. The digitised data can easily be manipulated to include the offset required for the cement gap.

The discrepancies are mitigated and any offsets are produced by machining the inner surface 24 of the coping 20. This could be carried out as a manual process but it is preferred that it is automated whereby a cutting program is produced to remove the excess material from the inner surface 34.

FIGS. 3a,b and c show stages in the production of a bridge. The bridge 50 comprises three parts, the bridge supports 50a,50c which are disposed one at each end of the bridge and the pontic 50b which is the replacement tooth or teeth which are to be provided by the bridge. In this example, only one tooth is being replaced. In order to make the bridge, a plaster model 52 of the relevant section of a patients' jaw is produced. In the production of a ceramic bridge, the plaster cast 52 digitised. Computer software is used to produce a virtual wax-up of the pontic and supporting coping. A green ceramic bridge is machined to size and shape from a pressed block. The machined green ceramic bridge is sintered to produce the ceramic bridge. As with coping production, the ceramic moulding of the bridge can be subject to thermal shrinkage causing problems with fitting the bridge to the patient. As the length of the bridge is at least three times that of a coping, any shrinkage is magnified over that length (FIG. 3c).

In order to alleviate the effects of shrinkage particularly in a bridge but also when a coping is being manufactured, the coping or bridge is made slightly thicker than required which enables machining of the inner surface of the coping(s) in order to provide a good fit with the cast of the coping or bridge (FIG. 3b)

In the case of a single coping one can merely compare the inner profile of the surface 24 (adjusted for the cement gap) with digitised data of the cast of the tooth form 22.

When a ceramic bridge 58 is involved a reference feature 60 is provided on the plaster cast 52 of the bridge 50. The reference feature may be a protrusion or a recess in fact, any discontinuity in the surface profile of the plaster cast which is large enough to be identified when the cast is digitised is applicable.

The reference feature is used to marry up digitised data of the supporting teeth 50a,50b of the plaster cast 52 with that of the inner surfaces of the supporting copings 56a,56b respectively. Either the whole bridge may be digitised or, a reference feature can be provided with respect to each coping which are digitised separately. The digitised data of the cast and inner coping surfaces are compared, any discrepancies identified, and a machining step carried out to remove the discrepancies and include any offsets. The ceramic bridge 58 is coated in enamel to produce the final shape and colour of the teeth.

Alternatively, instead of using a reference feature, the data can be aligned by using best fit techniques.

As an alternative to producing a virtual wax-up, the pontic 50b is made by building-up a real wax model 54 of a tooth lying between the supporting teeth 50a,50c. To complete the bridge, a thin layer of wax 56a,56b which connects to the wax model 54 is added to the surface of supporting teeth 50a,50b. This layer of wax 56a,56b represents a coping which will seat, in the patients' mouth, on each supporting tooth, with the pontic spanning the gap.

When using a real wax model, the reference feature would have to be located somewhere on the surface where wax is added and used to make the ceramic bridge 58. It is preferred that such a reference is not so close to the edge of the bridge so as to possibly induce a failure or weakness there.

As an alternative to producing a ceramic bridge structure, a metallic bridge may be produced. In this case, the wax model 54,56a,56b of the bridge is used as the pattern for an investment casting process. The wax model is removed from the plaster cast and dipped in slip producing a ceramic mould. The wax is removed from the ceramic mould by heating it then draining the liquid wax out. Finally the ceramic mould is filled with molten metal to produce a metallic bridge. The inner surfaces of the supporting copings are digitised and compared to the plaster cast digitised data. Any discrepancies are machined away additionally, any offsets are accounted for. As with the ceramic bridge, reference points may be provided or best fit techniques employed in order to assist in matching the two data sets. The metallic bridge is coated with enamel to produce the final bridge.

Although the bridge described in the example has a three part structure, bridges where two pontics are produced may also be made according to the invention.

FIG. 4 is a flow diagram detailing steps of the invention. The surface of the tooth preparation is digitised 110. The digitised data is related to a near net shape version of the denture 120. The near net shape version is machined 130 to produce a denture having an inner profile which substantially replicates the preparation surface 140.

The near net shape can be altered by machining as described above or by any other suitable material removal technique such as etching.

The surfaces may be identified by any known means. One way is to digitise the surface by scanning with a probe. The probe may be a contact probe or a non-contact (for example, a laser) probe. Other ways of identifying the surface include ultra sound, CT scanning, MRI scanning and X-rays.

The methods described herein are suitable for use with other materials employed in the manufacture of fixed dentures such as acrylics.

1. A method of manufacturing a fixed denture (18,58) comprising:
identifying the surface of a tooth preparation (110);
relating the identified surface to a near net shape version of the denture (120); and
altering the near net shape version (130) to produce a denture having an inner profile which substantially replicates the surface of the tooth preparation (140).

2. A method according to claim 1 wherein, the inner profile includes an offset (36).

3. A method according to claim 1 wherein, the surface of the tooth is identified by digitising the surface.

4. A method according to claim 3 wherein, data produced when the surface is digitised is manipulated by one or both or producing a wax model (54) or virtual wax-up of the denture.

5. A method according to claim 3 wherein, data produced when the surface is digitised is related to a near net shape version using best fit techniques.

6. A method according to claim 1 wherein, the near net shape is altered by machining.

7. A method according to claim 1 wherein, the near net shape version is a pre-formed sintered ceramic shell (20).

8. A method according to claim 7 wherein, the pre-formed sintered ceramic shell (20) comprises one of a plurality of standard tooth shapes (40) from which the most appropriate shape is chosen.

9. A method according to claim 7 wherein, the pre-formed sintered ceramic shell (20) comprises an individually produced tooth shape (42).

10. A method according to claim 7 wherein, the pre-formed sintered ceramic shell (20) is made by one of single (48) or double (49) sided pressing.

11. A method according to claim 1 wherein, a reference feature (60) is provided on both the near net shape version (50) and the preparation.

12. A fixed denture manufactured according to claim 1.
